(19) United States
(12) Patent Application Publication
(10) Pub. No.: US 2014/0041491 A1
(43) Pub. Date: Feb. 13, 2014

(54) MAGNETIC AUXILIARY MECHANISM FOR PIVOTED TOOL

(71) Applicants: Chung-Ming YING, Taichung City (TW); Ting-Chieh CHANG, Taichung City (TW)

(72) Inventors: Chung-Ming YING, Taichung City (TW); Ting-Chieh CHANG, Taichung City (TW)

(21) Appl. No.: 13/568,443

(22) Filed: Aug. 7, 2012

(51) Int. Cl. B25B 7/14

(52) U.S. Cl. 81/319

(57) ABSTRACT

A magnetic auxiliary mechanism for a pivoted tool is disclosed. When an adjustable magnetic member therein is set in a released state, a repelling force generated between the adjustable member and a fixed magnetic member helps to push handles of the pivoted tool to move in opposite directions, thereby facilitating operation. When the adjustable magnetic member is set in a locked state, an attracting force generated between the adjustable and fixed magnetic members helps to hold the handles of the pivoted tool together. The magnetic auxiliary mechanism provides simple overall appearance, convenient operation and safe storage to the pivoted tool.

### BACKGROUND OF THE INVENTION

1. Technical Field

The present invention relates to pivoted hand tools, and more particularly, to a magnetic auxiliary mechanism installed onto handles of a pivoted tool, such as scissors, shears and pliers, for facilitating operation or positioning of the handles.

2. Description of Related Art

Scissors, shears, pliers and other pivoted tools commonly have a pair of handles that are configured to be drawn together or separated apart to thereby close or open a pair of functional jaws. For realizing energy-saving operation, there is typically a compression spring provided between the paired handles, so that when the handles are released from a squeezing force, the resilience of the spring can help to push the handles apart, thereby facilitating the relatively laborious jaw-opening operation.

However, the conventional approach has its defects. First, after long-term use, the compression spring tends to have elastic fatigue, and become less effective in facilitating saving energy. In addition, the spring bridging between the two handles can make the appearance of the pivoted tool more complicated. Moreover, when the spring is intertwined with external articles, the smooth operation of the pivoted tool is compromised. Furthermore, the spring exposed in the air is likely to become rusty. It is therefore desirable to have an auxiliary mechanism for scissors that overcomes the defects of the prior art and provides improved auxiliary functions.

### SUMMARY OF THE INVENTION

In view of the need of an improved auxiliary mechanism, objective of the present invention is to provide a magnetic auxiliary mechanism for a pivoted tool, wherein the magnetic auxiliary mechanism facilitates opening of handles and therefore jaws of the pivoted tool, without adding significant complication to the appearance of the pivoted tool.

Another objective of the present invention is to provide a magnetic auxiliary mechanism for a pivoted tool, wherein the magnetic auxiliary mechanism facilitates opening of handles and therefore jaws of the pivoted tool so as to eliminate the risk of having elastic fatigue like the compression spring as used in the prior art for the same purpose.

Another objective of the present invention is to provide a magnetic auxiliary mechanism for a pivoted tool, wherein the magnetic auxiliary mechanism helps to position the handles when the pivoted tool is not in use, thereby allowing convenient and safe storage of the pivoted tool.

For achieving the foregoing objectives, in one embodiment of the present invention, a magnetic auxiliary mechanism for a pivoted tool that has two paired handles to be drawn together or separated apart to thereby close or open two paired functional jaws thereof is installed between the paired handles and comprises a fixed magnetic member, fixedly attached to one of the paired handles of the pivoted tool so that two magnetic poles thereof are immovable; and an adjustable magnetic member, pivotally attached to the other of the paired handles of the pivoted tool so that the adjustable magnetic member is rotatable to make two magnetic poles thereof exchange and thus switchable between a first magnetism state where the adjustable magnetic member magnetically repels the fixed magnetic member and a second magnetism state where the adjustable magnetic member magnetically attracts the fixed magnetic member.

With the inventive configuration, the disclosed magnetic auxiliary mechanism provides simple overall appearance, convenient operation and safe storage to the pivoted tool, thus being utility.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a pair of scissors having a magnetic auxiliary mechanism according to the present invention;

FIG. 2 shows the disclosed magnetic auxiliary mechanism exploded from the scissors of FIG. 1;

FIG. 2a is an enlarged view of the circled part of FIG. 2;

FIGS. 3 and 4 illustrate operation of the magnetic auxiliary mechanism;

FIG. 5 is a cross-sectional view of a controlling wheel of the magnetic auxiliary mechanism taken along Line 5-5 of FIG. 3;

FIG. 6 provides another embodiment of the disclosed magnetic auxiliary mechanism; and

FIG. 7 shows the disclosed magnetic auxiliary mechanism applied to a pair of shears; and

FIG. 8 is a schematic drawing showing the magnetic auxiliary mechanism of the present invention applied to a pair of pliers.

### DETAILED DESCRIPTION OF THE INVENTION

According to the present invention, a magnetic auxiliary mechanism is designed for a pivoted tool. It is well known that a pivoted tool typically has paired handles to be drawn together or separated apart to thereby close or open a pair of functional jaws. Examples of such pivoted tools include, but are not limited to, scissors, shears and pliers. The magnetic auxiliary mechanism of the present invention is configured to be installed between the paired handles.

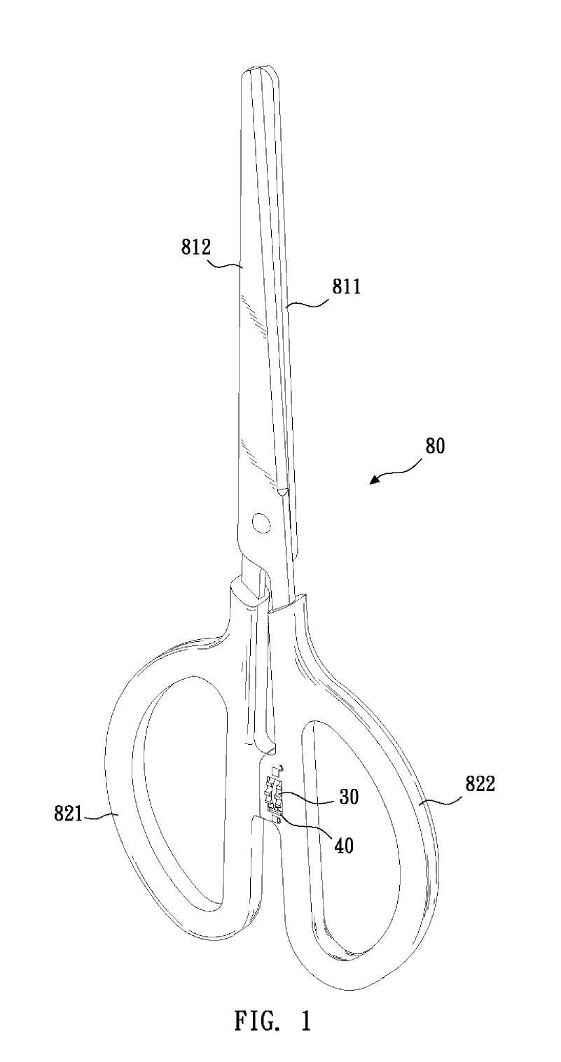

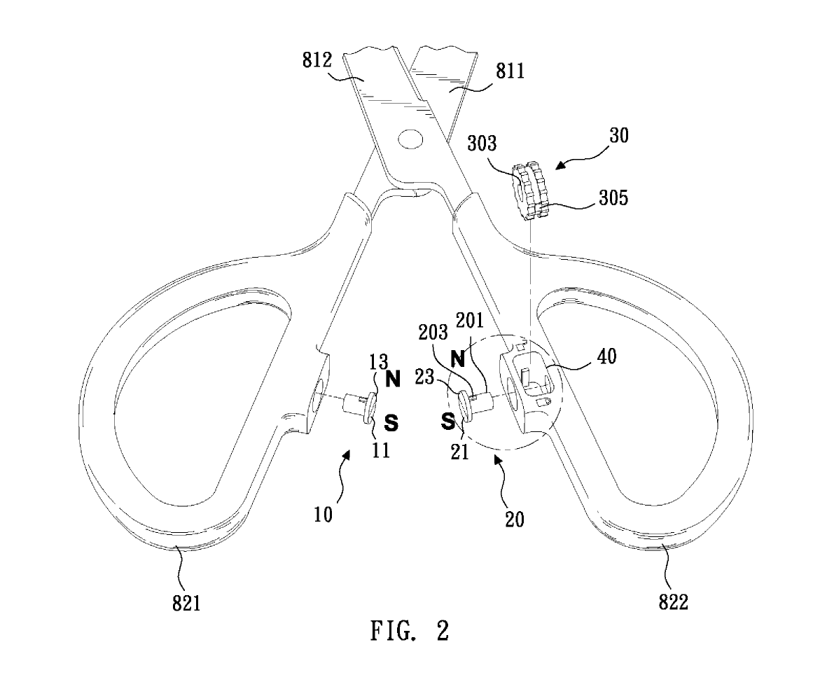

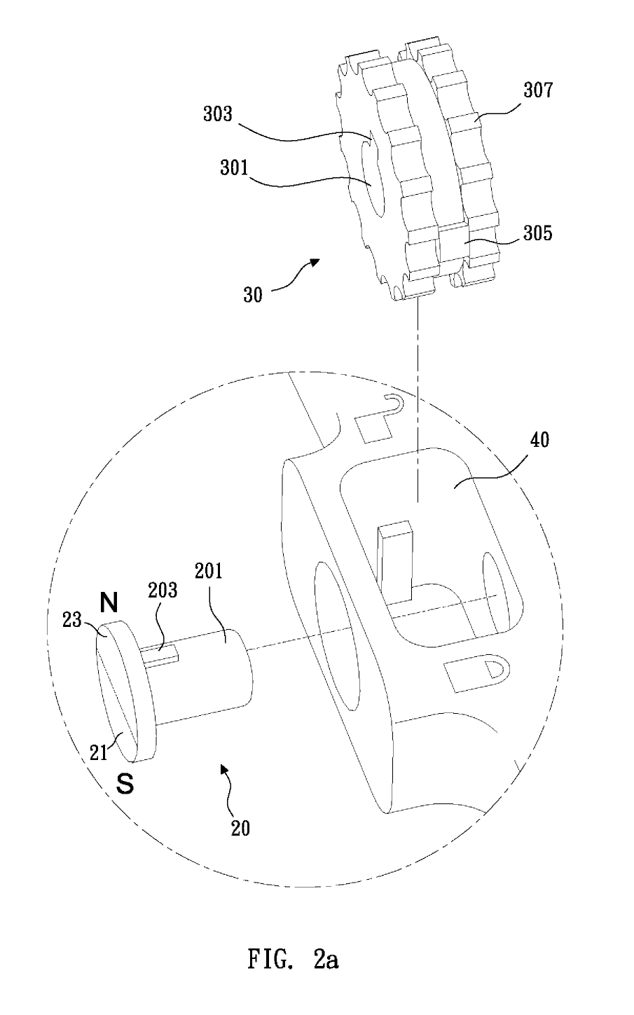

For illustrating the concept of the present invention, some preferred embodiments are provided and described herein. Please first refer to FIG. 1, FIG. 2 and FIG. 2a for a perspective view of a pair of scissors having the disclosed magnetic auxiliary mechanism and exploded views of the magnetic auxiliary mechanism from the scissors.

In the depicted embodiment, the scissors 80 has a pair of blades 811 and 812. When handles 821 and 822 of the scissors 80 are drawn together, the blades 811 and 812 approach each other. When the handles 821 and 822 are separated apart, the blades 811 and 812 move in opposite directions and open. The disclosed magnetic auxiliary mechanism is assembled to the handles 821 and 822, and primarily comprises a fixed magnetic member 10, an adjustable magnetic member 20 and a controlling wheel 30 for adjusting the adjustable magnetic member 20.

The fixed magnetic member 10 is fixed to the handle 821 and has its two magnetic poles S, N positioned immovably. The adjustable magnetic member 20 has two magnetic poles S, N, and is pivotally mounted on the other handle 822 such that it faces the fixed magnetic member 10. The adjustable magnetic member 20 is switched by the controlling wheel 30 to have its two poles S and N exchanging, thus making the adjustable magnetic member 20 be in a first magnetism state (or a released state) where it magnetically repels the fixed magnetic member 10 and a second magnetism state (or a locked state) where it magnetically attracts the fixed magnetic member 10. When the adjustable magnetic member 20 is switched to the released state, its two poles N and S are aligned with and repelled by the two poles N and S of the fixed magnetic member 10, respectively. When the adjustable magnetic member 20 is switched to the locked state, its two poles S and N are aligned with and attracted by the two poles N and S of the fixed magnetic member 10, respectively. In one preferred embodiment, as shown in FIG. 2 and FIG. 2a, the adjustable magnetic member 20 and the fixed magnetic member 10 each have a round sectional shape, with the N and S poles each taking a half of the round sectional shape. In other words, the N and S poles each take a semicircular area.

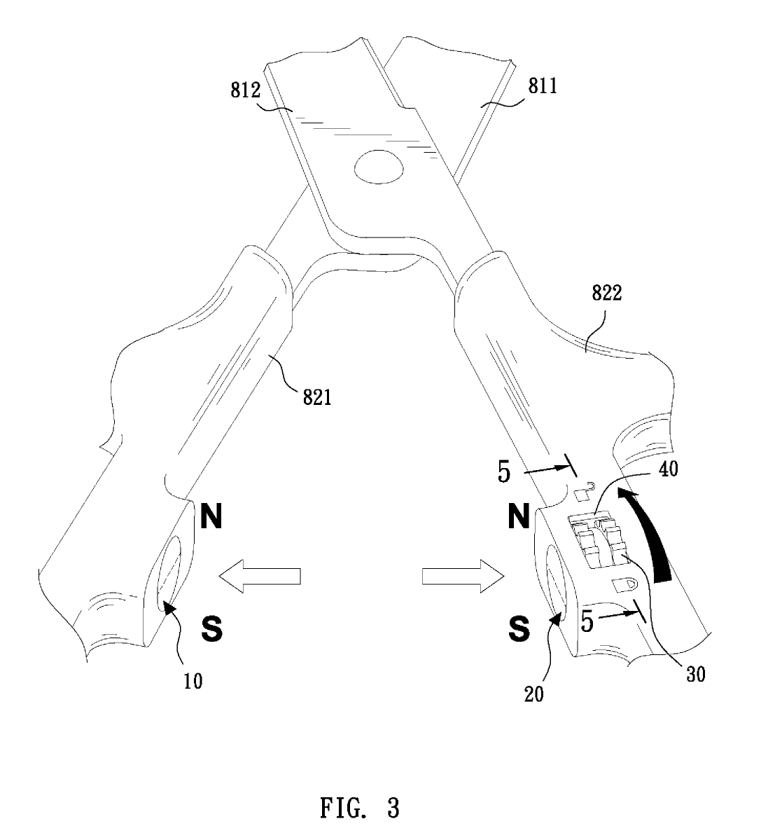

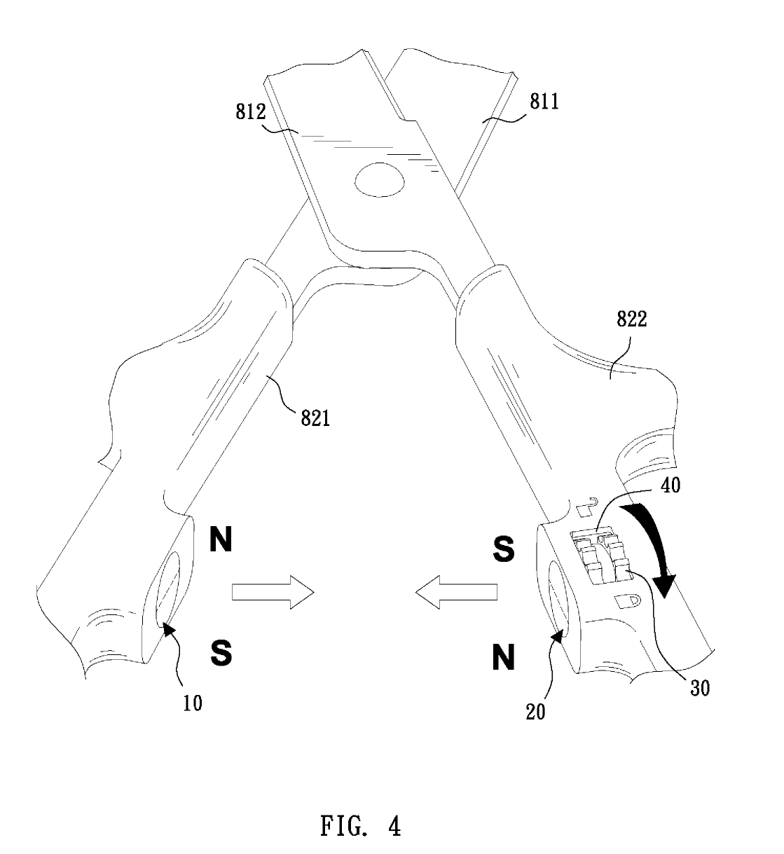

Thus, as shown in FIG. 3, when the adjustable magnetic member 20 is switched by the controlling wheel 30 into the released state, its S pole is aligned with the S pole of the fixed magnetic member 10, while its N pole is aligned with the N pole of the fixed magnetic member 10. At this time, a repelling force is generated between the adjustable magnetic member 20 and the fixed magnetic member 10 and pushes the two magnetic members 10 and 20 to move outward and remove from each other. On the contrary, when the adjustable magnetic member 20 is switched by the controlling wheel 30 into the locked state, its S pole is aligned with the N pole of the fixed magnetic member 10, while its N pole is aligned with the S pole of the fixed magnetic member 10. At this time, an attracting force is generated between the adjustable magnetic member 20 and the fixed magnetic member 10 and draws the two magnetic members 10 and 20 to move inward and approach each other, as shown in FIG. 4.

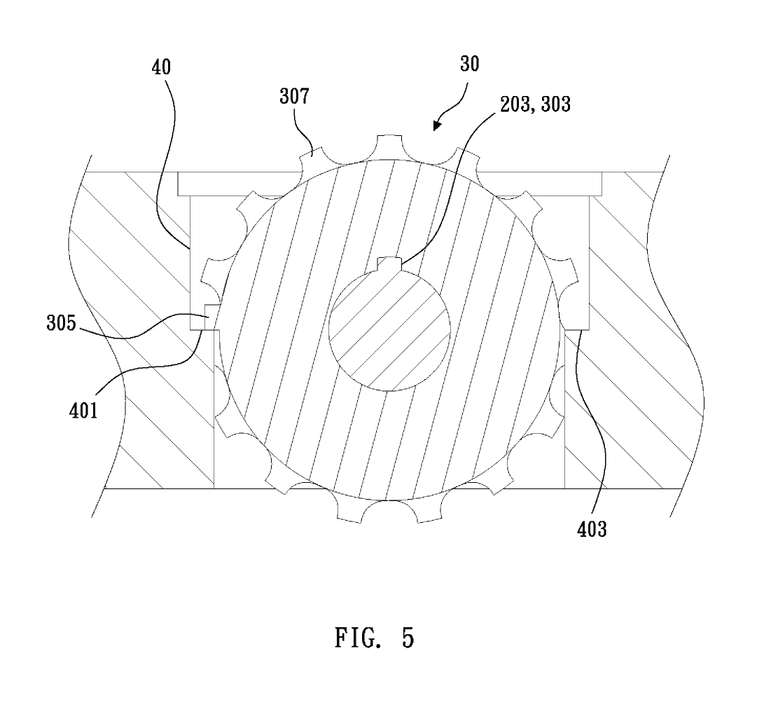

Referring to FIG. 2, FIG. 2a and FIG. 5, particularly, for realizing the foregoing operation, the controlling wheel 30 is received in a recess 40 formed on the handle 822 and has centrally a through axial hole 301. The adjustable magnetic member 20 has a pivot portion 201 that is configured to pass through the axial hole 301 of the controlling wheel 30 and be pivotally coupled to a wall defining the recess 40 of the handle 822. The pivot portion 201 and a wall defining the axial hole 301 may be fixedly combined by, for example, tight fit, binding, gluing or soldering. Alternatively, as shown in FIG. 2 and FIG. 5, the pivot portion 201 of the adjustable magnetic member 20 has a protrusion 203, and the wall of the axial hole 301 of the controlling wheel 30 is formed with a depression 303. When the pivot portion 201 is received in the axial hole 301, the protrusion 203 is engaged with the depression 303, so that the pivot portion 201 of the adjustable magnetic member 20 is prevented from rotating with respect to the controlling wheel 30. The combination of the protrusion 203 and the depression 303 is also helpful to position the magnetic poles of the magnetic members 10 and 20 during fabrication.

In addition, the controlling wheel 30 has a positioning block 305, while the recess 40 is formed with a first retaining edge 401 and a second retaining edge 403. When the controlling wheel 30 has its positioning block 305 retained by the first retaining edge 401, the controlling wheel 30 makes the adjustable magnetic member 20 be in its released state, and when the controlling wheel 30 has its positioning block 305 retained by the second retaining edge 403, the controlling wheel 30 makes the adjustable magnetic member 20 be in its locked state. Preferably, the controlling wheel 30 is peripherally formed with at least one rubbing tooth 307, so that a user's finger can easily rotate the controlling wheel 30 and switch the adjustable magnetic member 20 between the released state and the locked state.

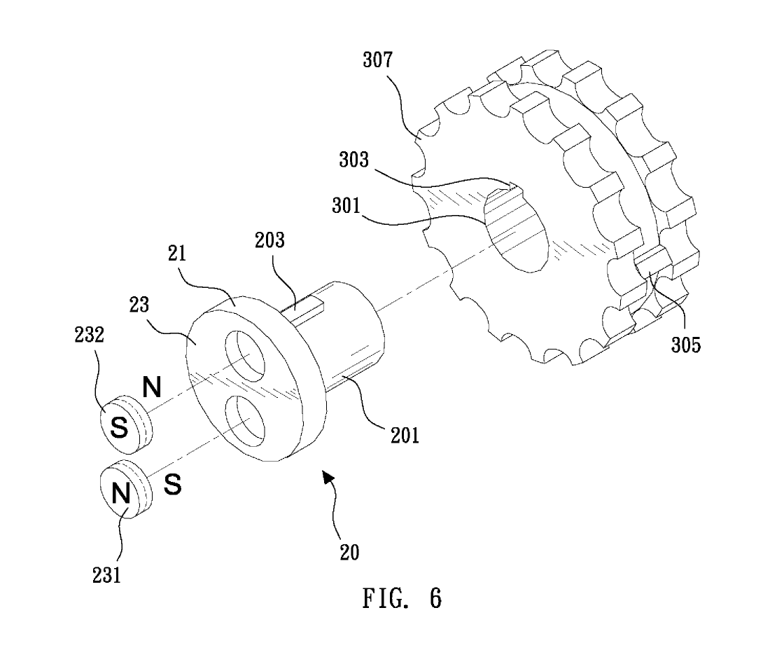

Moreover, as shown in FIGS. 2 and 6, in another embodiment of the present invention, for properly setting the magnetic poles of the fixed magnetic member 10 and the adjustable magnetic member 20, each of the magnetic members 10 and 20 has a seat 11 or 21. Taking the adjustable magnetic member 20 for example, the seat 21 has an acting surface 23 inlaid with two magnets 231 and 232. The magnets 231 and 232 face the acting surface 13 of the magnetic member seat 11 with different magnetic poles N and S.

Thereby, for using the pivoted tool, a user may rotate the controlling wheel 30 in the direction indicated in FIG. 3. In virtue of the fixed combination between the controlling wheel 30 and the pivot portion 201, the controlling wheel 30 drives the adjustable magnetic member 20 to rotate in the recess 40 toward the first retaining edge 401. When the positioning block 305 of the controlling wheel 30 is retained by the first retaining edge 401, the adjustable magnetic member 20 is at its released state, where its S pole is aligned with the S pole of the fixed magnetic member 10 and its N pole is aligned with the N pole of the fixed magnetic member 10. At this time, the repelling force existing between the two magnetic members 10 and 20 helps to push the handles 821 and 822 outward and keep open. Thereby, when not squeezed by the user, the handles 821 and 822 can automatically remove from each other to allow energy-saving operation like the compression spring used in the traditional scissors does, but will not add complication to the appearance of the pivoted tool or bring about the risk of being intertwined with external articles like the compression spring used in the traditional scissors does.

As shown in FIG. 4, when the pivoted tool is not in use, a user may rotate the controlling wheel 30 in the direction indicated in FIG. 4. In virtue of the fixed combination between the controlling wheel 30 and the pivot portion 201, the controlling wheel 30 drives the adjustable magnetic member 20 to rotate in the recess 40 toward the second retaining edge 403. When the positioning block 305 of the controlling wheel 30 is retained by the second retaining edge 403, the adjustable magnetic member 20 is at its locked state, where its S pole is aligned with the N pole of the fixed magnetic member 10, and its N pole is aligned with the S pole of the fixed magnetic member 10. At this time, the attracting force existing between the two magnetic members 10 and 20 helps to hold the handles 821 and 822 together. Thereby, the pivoted tool not in use can be held in a close state that facilitate storage and prevents the blades 811 and 812 from accidentally opening to damage articles or hurt people.

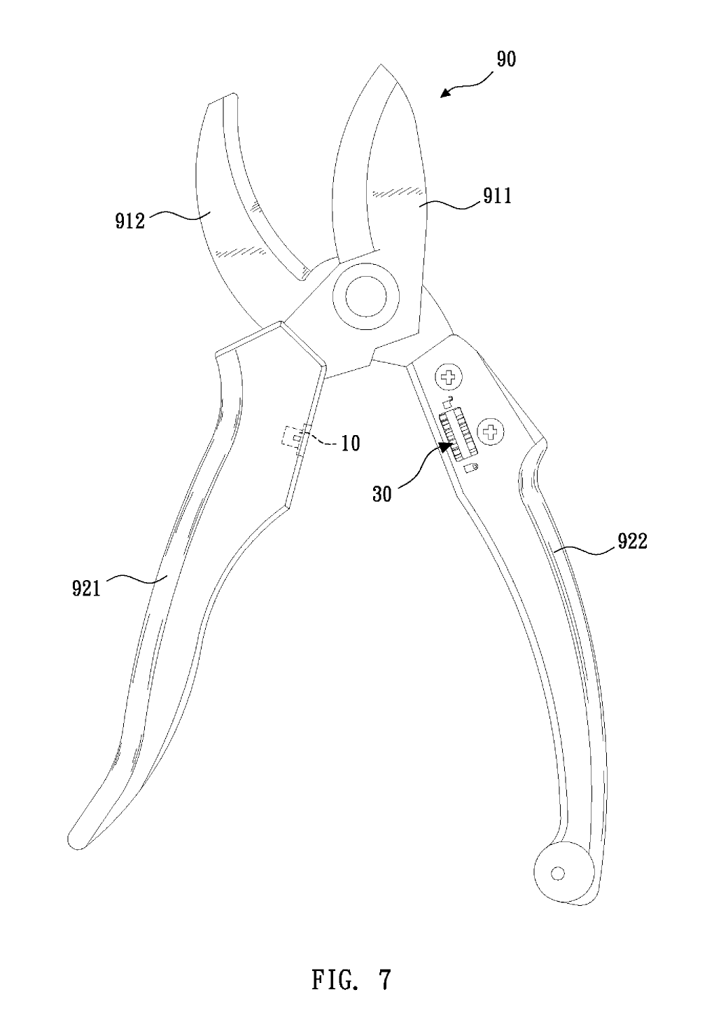

Referring to FIG. 7, the disclosed magnetic auxiliary mechanism is assembled to a pair of shears 90. When handles 921 and 922 are drawn together, blades 911 and 912 of the shears 90 are drawn together, and vice versa. The fixed magnetic member and the adjustable magnetic member of the disclosed magnetic auxiliary mechanism are mounted onto the handles 921 and 922, respectively, with the controlling wheel 30 raised from the handle 922 for a user's easy operation.

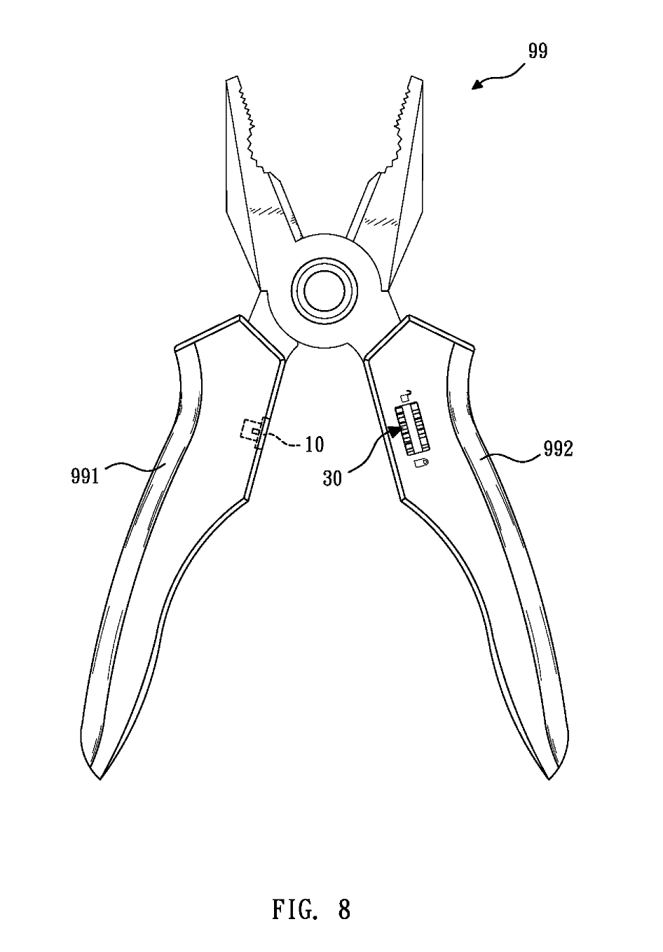

FIG. 8 is a schematic drawing showing the magnetic auxiliary mechanism of the present invention applied to a pair of pliers 99. Therein, the fixed magnetic member 10 and the adjustable magnetic member (not shown) of the disclosed magnetic auxiliary mechanism are mounted onto handles 991 and 992, respectively, with the controlling wheel 30 raised from the handle 992 for a user's easy operation.

In comparison with the traditional approach using a spring to facilitate operation, the disclosed magnetic auxiliary mechanism adds less complication to the appearance of the pivoted tool, and eliminates the risks of being intertwined with external articles and having elastic fatigue, thereby ensuring the pivoted tool having it to be more aesthetic, manageable and durable. In addition, the disclosed magnetic auxiliary mechanism helps to position the handles when the pivoted tool is not in use, thereby allowing convenient and safe storage of the pivoted tool.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

1. A magnetic auxiliary mechanism for a pivoted tool that has two paired handles to be drawn together or separated apart to thereby close or open two paired functional jaws thereof, the magnetic auxiliary mechanism being installed between the paired handles and comprising:
a fixed magnetic member, fixedly attached to one of the paired handles of the pivoted tool so that two magnetic poles thereof are immovable; and
an adjustable magnetic member, pivotally attached to the other of the paired handles of the pivoted tool and the adjustable magnetic member is installed onto a controlling wheel, wherein the controlling wheel is received in a recess formed on the handle having the adjustable magnetic member, and has a through axial hole, while the adjustable magnetic member has a pivot portion that is configured to pass through the axial hole of the controlling wheel and then be pivotally coupled to a wall of the recess on the handle, while the pivot portion of the adjustable magnetic member comprises a protrusion, and a wall defining the axial hole of the controlling wheel has a depression, so that when the pivot portion is received in the axial hole, the protrusion is fittingly received in the depression, thereby positioning the pivot portion of the adjustable magnetic member in the axial hole of the controlling wheel and preventing the pivot portion of the adjustable magnetic member from rotating with respect to the axial hole of the controlling wheel to ensure that the pivot portion of the adjustable magnetic member is fixedly received in the axial hole of the controlling wheel, with one part of the controlling wheel exposed at the outside of the recess so that the adjustable magnetic member is rotatable to make two magnetic poles thereof exchange and thus switchable between a first magnetism state where the adjustable magnetic member magnetically repels the fixed magnetic member and a second magnetism state where the adjustable magnetic member magnetically attracts the fixed magnetic member, moreover, the controlling wheel has a positioning block, and the recess has a first retaining edge and a second retaining edge, so that when stopped by the first retaining edge at the positioning block, the controlling wheel makes the adjustable magnetic member be in the first magnetism state, and when stopped by the second retaining edge at the positioning block, the controlling wheel makes the adjustable magnetic member be in the second magnetism state.

2. (canceled)

3. (canceled)

4. (canceled)

5. (canceled)

6. (canceled)

7. The magnetic auxiliary mechanism of claim 1, wherein the controlling wheel is peripherally formed with at least one rubbing tooth.

8. The magnetic auxiliary mechanism of claim 1, wherein each of the fixed magnetic member and the adjustable magnetic member has a seat and two magnets are inlaid at an acting surface of the seat, in which the magnets face the acting surface of the other magnetic member seat with different magnetic poles.

9. The magnetic auxiliary mechanism of claim 1, wherein the pivoted tool is selected from the group consisting of a pair of scissors, a pair of shears, and a pair of pliers.
